(19) United States
(12) Patent Application Publication
(10) Pub. No.: US 2024/0249527 A1
(43) Pub. Date: Jul. 25, 2024

(54) SENSOR DATA MAPPING FOR PERSPECTIVE VIEW AND TOP VIEW SENSORS FOR MACHINE LEARNING APPLICATIONS

(71) Applicant: QUALCOMM Incorporated, San Diego, CA (US)

(72) Inventors: Balaji Shankar Balachandran, San Diego, CA (US); Varun Ravi Kumar, San Diego, CA (US); Senthil Kumar Yogamani, Headford (IE)

(21) Appl. No.: 18/158,990

(22) Filed: Jan. 24, 2023

(51) Int. Cl. G06V 20/56; G06T 3/40; G06T 7/60; G06T 9/00; G06T 17/00; G06V 10/70

(52) U.S. Cl. CPC G06V 20/56; G06T 3/4053; G06T 7/60; G06T 9/00; G06T 17/00; G06V 10/70; G06T 2207/20081; G06T 2207/30252

(57) ABSTRACT

This disclosure provides systems, methods, and devices for vehicle driving assistance systems that support image processing. In a first aspect, a method is provided that includes receiving sensor data from a plurality of sensors on a vehicle and determining a three-dimensional representation of an area surrounding the vehicle by mapping the sensor data onto a three-dimensional surface. The plurality of sensors may include at least one perspective view sensor and at least one top view sensor, and the three-dimensional surface may include sensor data from the at least one perspective view sensor and sensor data from the at least one top view sensor. The method may further include determining, with a machine learning model, one or more characteristics of the area surrounding the vehicle based on the three-dimensional representation. Other aspects and features are also claimed and described.

### TECHNICAL FIELD

Aspects of the present disclosure relate generally to driver-operated or driver-assisted vehicles, and more particularly, to methods and systems suitable for processing sensor data for improved machine learning processing, such as for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road.

One aspect includes a method that includes receiving sensor data from a plurality of sensors on a vehicle, where the plurality of sensors includes at least one perspective view sensor and at least one top view sensor. The method also includes determining a three-dimensional representation of an area surrounding the vehicle by mapping the sensor data onto a three-dimensional surface, where the three-dimensional surface includes sensor data (or is based on the sensor data) from the at least one perspective view sensor and sensor data from the at least one top view sensor, where the three-dimensional surface is continuous. Mapping the sensor data onto the three-dimensional surface may include mapping sensor data from the at least one perspective view sensor onto sides of the three-dimensional surface, and mapping sensor data from the at least one top view sensor onto a top of the three-dimensional surface. The method also includes determining, with a machine learning model, one or more characteristics of the area surrounding the vehicle based on the three-dimensional representation.

Another aspect includes an apparatus that includes a memory storing processor-readable code. The apparatus also includes at least one processor coupled to the memory, the at least one processor configured to execute the processor-readable code to cause the at least one processor to perform operations. The operations may include receiving sensor data from a plurality of sensors on a vehicle, where the plurality of sensors includes at least one perspective view sensor and at least one top view sensor. The operations also include determining a three-dimensional representation of an area surrounding the vehicle by mapping the sensor data onto a three-dimensional surface, where the three-dimensional surface includes sensor data from the at least one perspective view sensor and sensor data from the at least one top view sensor, where the three-dimensional surface is continuous, and where mapping the sensor data onto the three-dimensional surface includes: mapping sensor data from the at least one perspective view sensor onto sides of the three-dimensional surface; and mapping sensor data from the at least one top view sensor onto a top of the three-dimensional surface. The operations also include determining, with a machine learning model, one or more characteristics of the area surrounding the vehicle based on the three-dimensional representation.

A further aspect includes a non-transitory computer-readable medium storing instructions that that, when executed by a processor, cause the processor to perform operations. The operations may include receiving sensor data from a plurality of sensors on a vehicle, where the plurality of sensors includes at least one perspective view sensor and at least one top view sensor. The instructions also include determining a three-dimensional representation of an area surrounding the vehicle by mapping the sensor data onto a three-dimensional surface, where the three-dimensional surface includes sensor data from the at least one perspective view sensor and sensor data from the at least one top view sensor, where the three-dimensional surface is continuous, and where mapping the sensor data onto the three-dimensional surface includes: mapping sensor data from the at least one perspective view sensor onto sides of the three-dimensional surface; and mapping sensor data from the at least one top view sensor onto a top of the three-dimensional surface. The instructions also include determining, with a machine learning model, one or more characteristics of the area surrounding the vehicle based on the three-dimensional representation.

An additional aspect includes a vehicle that a memory storing processor-readable code. The vehicle also includes at least one processor coupled to the memory, the at least one processor configured to execute the processor-readable code to cause the at least one processor to perform operations including: receiving sensor data from a plurality of sensors on a vehicle, where the plurality of sensors includes at least one perspective view sensor and at least one top view sensor; determining a three-dimensional representation of an area surrounding the vehicle by mapping the sensor data onto a three-dimensional surface, where the three-dimensional surface includes sensor data from the at least one perspective view sensor and sensor data from the at least one top view sensor, where the three-dimensional surface is continuous. Mapping the sensor data onto the three-dimensional surface includes mapping sensor data from the at least one perspective view sensor onto sides of the three-dimensional surface; and mapping sensor data from the at least one top view sensor onto a top of the three-dimensional surface. The operations may include determining, with a machine learning model, one or more characteristics of the area surrounding the vehicle based on the three-dimensional representation.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5^{th} Generation (5G) or new radio (NR) networks (sometimes referred to as “5G NR” networks, systems, or devices), as well as other communications networks. As described herein, the terms “networks” and “systems” maybe used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” maybe substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” maybe understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 depicts a system for processing sensor data for machine learning applications according to an exemplary embodiment of the present disclosure.

FIG. 5A depicts a three-dimensional surface according to an exemplary embodiment of the present disclosure.

FIGS. 5B-5C depict sampling scenarios according to exemplary embodiments of the present disclosure.

FIG. 6 is a flow chart illustrating an example method for processing sensor data for machine learning applications according to an exemplary embodiment of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support improved processing of sensor data for use in machine learning applications, such as by preparing a single continuous input data surface for use by machine learning models that combines sensor data from multiple views.

The problem of environmental modelling (such as for vehicle applications) may not typically be well-developed for machine learning approaches, such as deep learning techniques. In certain instances, well-structured environments may be represented reasonably well by abstract models like feature maps where fewer details are preserved. However, more diverse environments however need more detailed and less abstract representations to accurately perceive and process. In certain implementations, 3D voxel representations may be used, but may also be memory and computing resource intensive. In further instances, top-down views may utilize fewer computing resources, but may also struggle to capture an environment holistically. An increase in multi-task learning techniques may accordingly require efficient environmental modelling that works for diverse downstream tasks without utilizing excessive computing resources.

In certain instances, multi-view deep learning networks may be used for perception tasks, but may require separate branches and separate processing for different views. This can increase the sensor data pipeline's complexity, and can greatly increase the computing resources necessary to implement the model. Furthermore, maintaining separate branches or models for different sensor views may limit the holistic feature learning across different views for downstream tasks. Furthermore, simply fusing features from different views is not straightforward due to inherent differences in views and best representation methods for different sensors, which may require custom representations for different sensor combinations or different vendors.

One solution to this problem is to provide a unified composite representation of top view and perspective view sensor data. The representation may include mapping the sensor data onto a three-dimensional surface, such as a continuous three-dimensional surface. In certain implementations, perspective view sensor day may be mapped onto the sides of the surface and top view sensor data may be mapped onto a top of the surface. For example, the three-dimensional surface may be a hollow capped cylinder with a continuous, smooth transition region between the sides of the cylinder and the top of the cylinder. In such instances, the mapped sensor data may then be used by one or more machine learning models that are trained to perform one or more tasks based on sensor data that has been mapped onto corresponding three-dimensional surfaces.

Stated differently, fusing deep learning (DL) features from different sensors (such as a camera in perspective view, and LiDAR in top view) may be challenging due to inherent differences in view and best representation methods for different sensors. The present disclosure proposes techniques that use a unified composite representation to combine the benefits of perspective view and top view. To represent a scene in a unified view, the walls and top of the view may be constructed from different sensor inputs and views. For example, the perspective view/range view inputs may be mapped onto the walls and top view inputs may be mapped onto the top. In another aspect, a finer sampling method may be proposed based on road geometry to improve long range perception, where the road's vanishing point may be estimated to incorporate finer grids in the direction of travel for the vehicle. Notable aspects may include (1) designing a composite surface that maps to output space and feature space, enabling better deep learning model development, (2) deep learning architecture to directly map features from multiple perspectives and sensors onto the proposed surface using transformers (such as kernel transformers), (3) flexible grid sampling on the surface incorporating customer requirements (such as range, resolution, etc.) for efficient modeling of the environment, and (4) using vanishing point in grid sampling techniques to leverage long-range perception.

Particular implementations of the subject matter described in this disclosure may be implemented to realize one or more of the following potential advantages or benefits. In some aspects, the present disclosure provides techniques for image processing that may be particularly beneficial in smart vehicle applications. For example, the present techniques may enable machine learning models to utilize unified perspective learning across multiple views, including view agnostic feature learning and features that combine aspects from multiple views (such as perspective views and top views. By combining different views into a single, continuous input surface, the present techniques avoid the need for multiple branches within models to handle separate views. This may reduce model size and the corresponding computing resources necessary to implement the machine learning model and to train the model. Furthermore, mapping two-dimensional sensor data onto a three-dimensional surface may significantly reduce the input file sizes necessary when compared to three-dimensional input data. However, by combining multiple views, models utilizing the single continuous input data space may still achieve similar accuracy levels to models that receive and require three-dimensional input data. Accordingly, such models may have similar levels of accuracy while reducing file bandwidth costs, data storage costs, model size, model complexity, and the computing resources required to implement or train the model. Given the memory and computing requirements for typical deep learning models, these techniques may enable greater use of deep learning models for vehicle guidance and similar related processes.

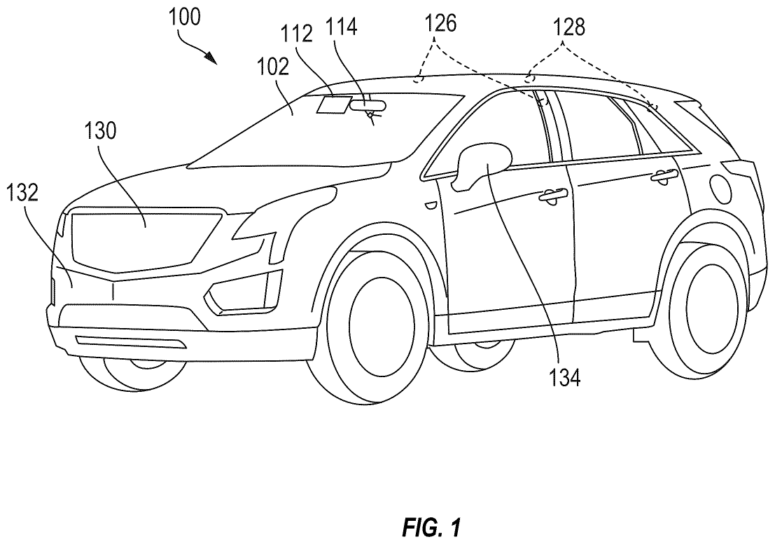

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or in a forward direction. In some embodiments, an additional camera may be located at the rear of the vehicle 100 and oriented such that the field of view of the additional camera captures a scene behind the vehicle 100 in the direction that the vehicle 100 is moving when in reverse mode or in a reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the vehicle 100 is traveling in a forward direction may likewise be obtained while the vehicle 100 is traveling in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

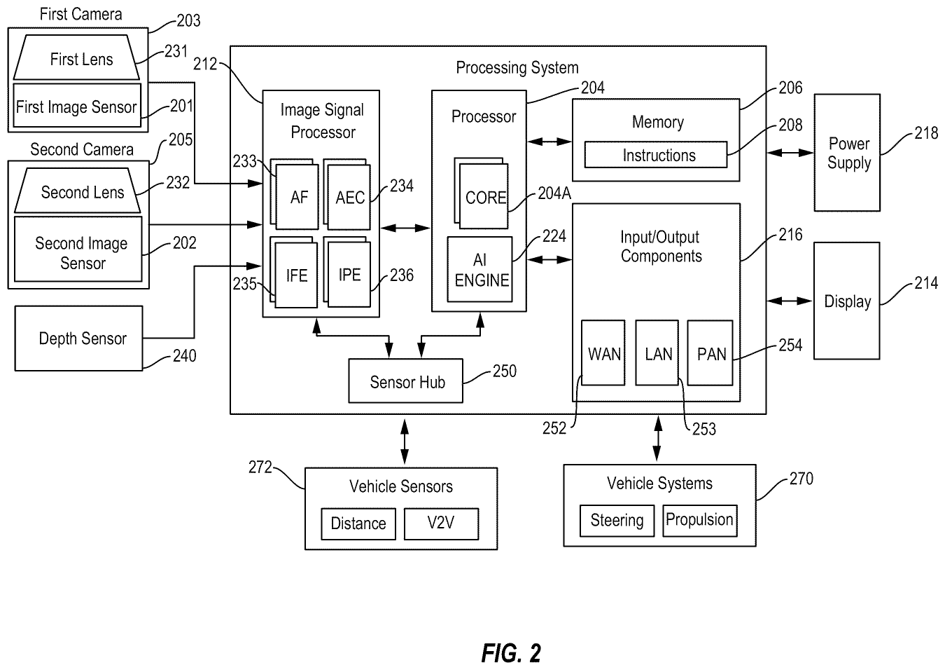

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

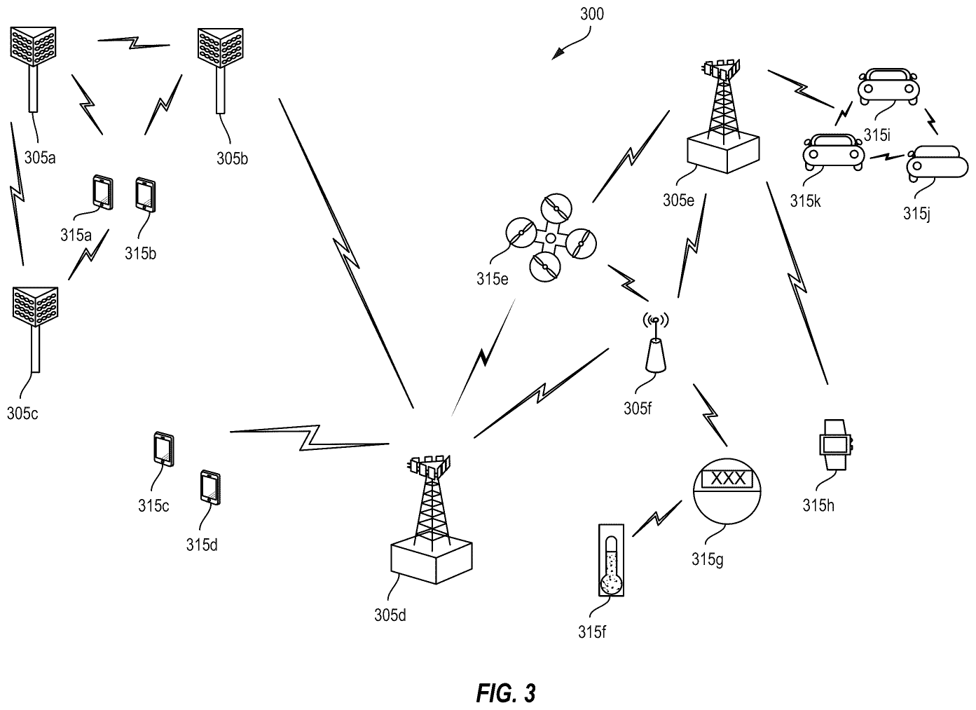

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports mission critical communications with ultra-reliable and redundant links for mission critical devices, such UE 315e, which is a drone. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e.

Aspects of the vehicular systems described with reference to, and shown in, FIG. 1, FIG. 2, and FIG. 3 may include improved processing of sensor data received from sensors located on vehicles, such as improved data processing to enable the use of sensor data from multiple sensors by individual machine manning models for use in various vehicle applications.

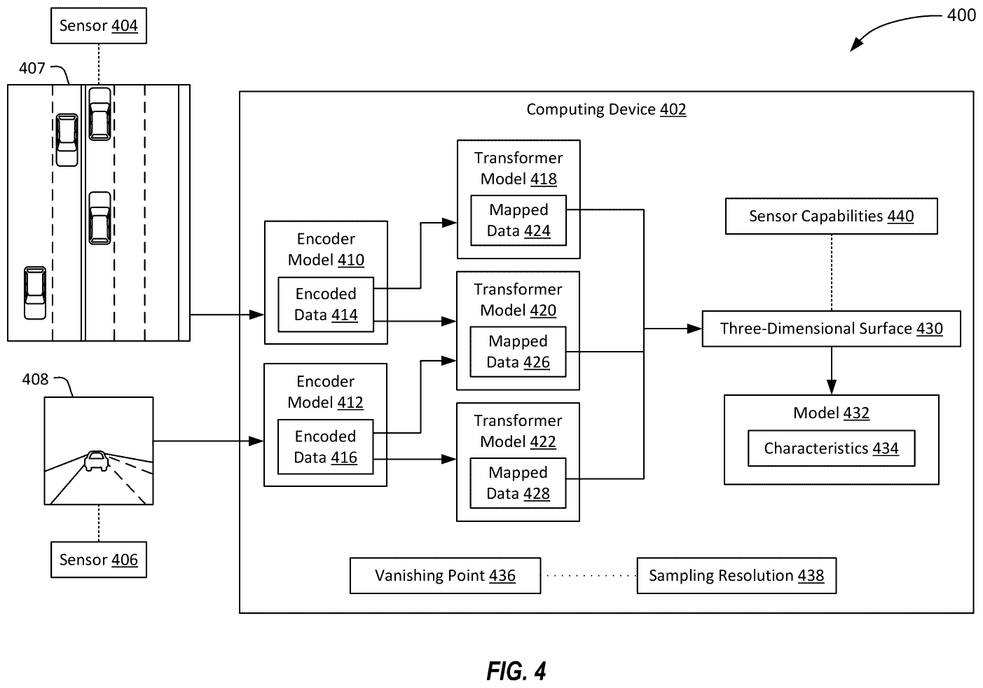

FIG. 4 depicts a system 400 for processing sensor data for machine learning applications according to an exemplary embodiment of the present disclosure. The system 400 includes a perspective view sensor 406, a top view sensor 404, sensor data 407, 408, and a computing device 402. The computing device 402 includes encoder models 410, 412, transformer models 418, 420, 422, a three-dimensional surface 430, sensor capabilities 440, a vanishing point 436, a sampling resolution 438, and a model 432. The encoder models 410, 412 include! encoded data 414, 416 and the transformer models 418, 420, 422 include mapped data 424, 426, 428. The model 432 includes characteristics 434, such as characteristics of an area surrounding a vehicle from which the sensor data 407, 408 was captured.

The computing device 402 may be configured to receive sensor data 407, 408 from a plurality of sensors 404, 406 on a vehicle, such as the vehicle 100. The plurality of sensors 404, 406 may include at least one perspective view sensor 406 and at least one top view sensor 404. In certain implementations, the plurality of sensors 404, 406 may include one or more image sensors, LIDAR sensors, radar sensors, ultrasonic sensors, and the like. In certain implementations, the vehicle may have multiple different types of sensors, such as at least one LIDAR-based perspective view sensor 406 and at least one image sensor-based top view sensor 404s. In such instances, different data types from different sensors may be adapted to a common format for further processing. For example, LIDAR sensor data 407, 408 may be converted to image data (such as where differences in color or intensity indicate different depth measurements). In certain implementations, the sensor data 407, 408 may be captured using log polar sampling techniques.

In certain implementations, the perspective view captured by a perspective view sensor 406 may be an outward-facing view of the area surrounding the vehicle. For example, as shown in FIG. 4, sensor data 408 collected from a perspective view sensor 406 may include image data captured by outward-facing cameras positioned on the vehicle (such as looking outward from the dashboard, side mirrors, and a rear of the vehicle). In certain implementations, the top view captured by a top view sensor 404 may be a top-down view of the vehicle and the area surrounding the vehicle. In certain implementations, the top view may also be referred to as a bird's eye view (BEV). For example, as shown in FIG. 4, sensor data 407 collected from a top view sensor 404 may include LIDAR distance measurements of objects in the area surrounding the vehicle captured from one or more LIDAR sensor positioned on top of the vehicle. In certain implementations, the sensor data 407 may be composited or otherwise transformed from the perspective of the sensors to provide the top view. Perspective view sensor data 408 and top view sensor data 407 may offer improved performance for different types of environment details. For example, perspective view sensor data may provide improved detail for feature extraction of objects like traffic signs, pedestrians, overpasses, and bridges, while top view sensor data may provide more detail for the overall structure of objects like bridges, overpasses, and positional information for roads.

In certain implementations, the sensor data 407, 408 may be two-dimensional data, such that spatial pixels within the sensor data 407, 408 have individual corresponding data points and do not provide three-dimensional spatial information. For example, sensor data 407, 408 from perspective view sensors 406 may be two-dimensional image data and sensor data 407, 408 from top view sensors 404 may be a two-dimensional top-down representation of the area surrounding the vehicle.

The computing device 402 may be configured to determine a three-dimensional representation of an area surrounding the vehicle by mapping the sensor data 407, 408 onto a three-dimensional surface 430. In particular, the three-dimensional surface 430 may include sensor data 407 from the at least one perspective view sensor 404 and sensor data 408 from the at least one top view sensor 404. In certain implementations, the three-dimensional surface 430 may be continuous. For example, the continuous surface may smoothly transition between a first portion of the surface and a second portion of the surface (such as without discontinuities or edges). In certain implementation, the first portion may be sides of the surface and the second portion may be a top of the surface. For example, the first and second portions may be substantially perpendicular to one another. In certain implementations, a third portion of the surface may transition from the first portion to the second portion (such as smoothly transition).

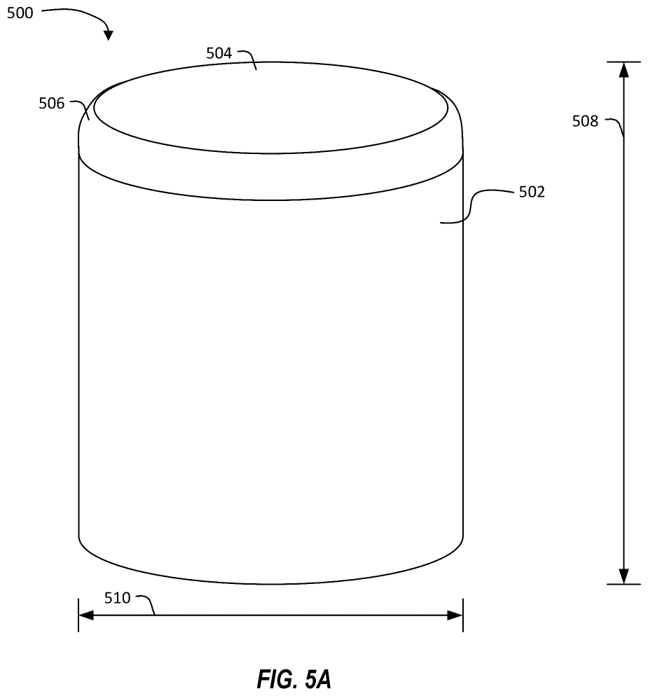

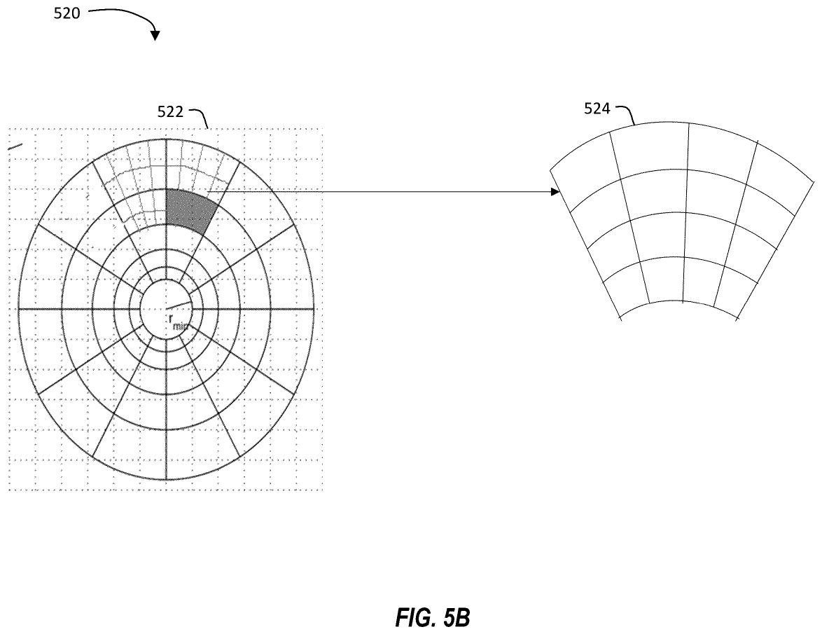

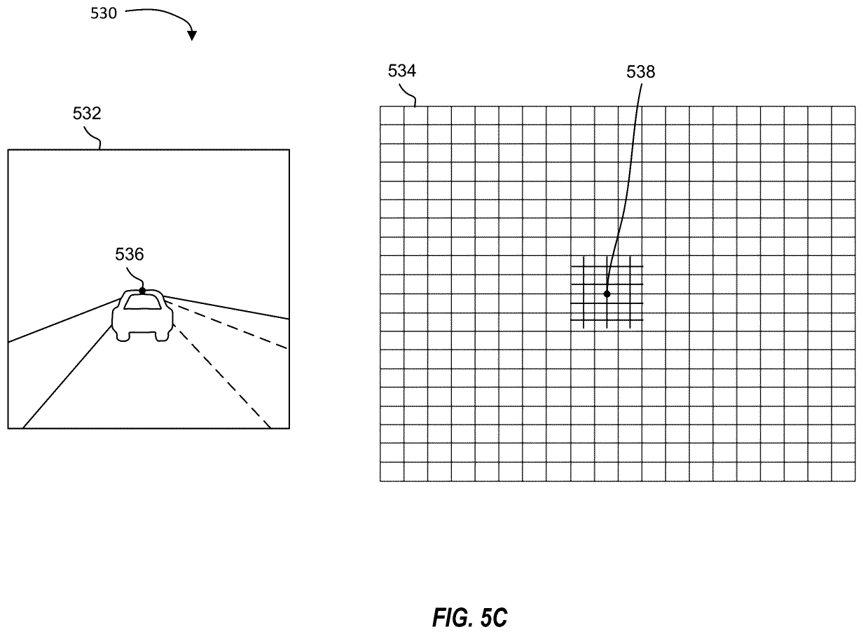

In certain implementations, the three-dimensional surface 430 may be a capped cylinder with a rounded edge. For example, FIG. 5A depicts a three-dimensional surface 500 according to an exemplary embodiment of the present disclosure. The three-dimensional surface 500 includes a top surface 504, a side surface 502, a transition surface 506, a height 508, a width 510. In certain implementations, the side surface 502 may represent a first portion of the three-dimensional surface 500, the top surface 504 may represent a second portion of the three-dimensional surface 500, and the transition surface 506 may represent a third portion of the three-dimensional surface 500. As can be seen in FIG. 5A, the side surface 502 is cylindrical in shape and may represent a hollow cylinder. The top surface 504 may cap the hollow cylinder formed by the side surface 502, and the transition surface 506 may continuously transition between the side surface 502 and the top surface 504 (such as with a rounded surface that smoothly connects the surfaces 502, 504). Notably, although an edge is depicted in FIG. 5A to identify the bounds of the top surface 504, the transition surface 506 and the top surface 504 may meet smoothly (such as without any edges or other discontinuities). Similarly, although an edge is depicted to identify the bounds of the side surface 502, the transition surface 506 and the side surface 502 may meet smoothly (such as without any edges or other discontinuities). One skilled in the art should appreciate that the three-dimensional surface 500 is only an exemplary implementation of a three dimensional surface 430 that may be used with the system 400. In additional or alternative implementations, other types of surfaces may be used, including other types of capped cylinders (such as capped cylinders with a larger or smaller transition surface), other types of continuous surfaces, and other types of non-continuous surfaces.

Returning to FIG. 4, in certain implementations, mapping the sensor data 407, 408 onto the three-dimensional surface 430 may include mapping sensor data 408 from the at least one perspective view sensor 406 onto a first portion of the three-dimensional surface 430 and mapping sensor data 407 from the at least one top view sensor 404 onto a second portion of the three-dimensional surface 430. Mapping the data may include transforming the contents of the sensor data 407, 408 onto the contours of the three-dimensional surface 430 (such that, when combined, the mapped data 424, 426, 428 forms the same or similar shape as the three-dimensional surface 430). As discussed further below, in certain implementations the sensor data 407, 408 may be encoded when received to form encoded data 414, 416. In such instances, corresponding encoded data 414, 416 may be mapped onto the three-dimensional surface 430. For example, the encoded data 414 may be mapped instead of the sensor data 407 and the encoded data 416 may be mapped instead of the sensor data 408.

Mapping the data may be performed by one or more models, such as one or more machine learning models, configured to translate the two-dimensional sensor data 407, 408 and/or encoded data 414, 416 into mapped data 424, 426, 428 that follows the three-dimensional contours of the three-dimensional surface 430. For example, the mapped data may be generated by one or more transformer models 418, 420, 422. For example, sensor data 408 or corresponding encoded data 416 from the at least one perspective view sensor 406 may be mapped onto the first portion of the three-dimensional surface 430 by a first transformer model 422, sensor data 407 or corresponding encoded data 414 from the at least one top view sensor 404 may be mapped onto the second portion of the three-dimensional surface 430 by a second transformer model 418, and sensor data 407, 408 or corresponding encoded data 414, 416 from both the at least one perspective view sensor 406 and the at least one top view sensor 404 may be mapped onto a third portion between the sides and top of the three-dimensional surface 430 by a third transformer model 420. The transformer models 418, 420, 422 may then generate, based on the received sensor data 407, 408 or corresponding encoded data 414, 416, mapped data 424, 426, 428 that maps the received data onto the contours of the three-dimensional surface 430. For example, when combined, the mapped data 424, 426, 428 may form the three-dimensional surface 430 and may contain corresponding data points from the sensor data 407, 408 or corresponding encoded data 414, 416.

In certain implementations, sensor data 407, 408 from the at least one perspective sensor and sensor data 407 from the at least one top view sensor 404 may separately encoded by corresponding encoder models 410, 412 before being mapped onto the three-dimensional surface 430. In certain implementations, the encoded data 414, 416 may encode the sensor data 407, 408 to correct for distortions (such as lens distortions), to generate different views or perspectives (such as generating a top view from sensor data 407 from a top view sensor 404), to combine data from multiple sensors (such as multiple perspective view sensors 406, multiple top view sensors), and the like. In certain implementations, the encoded data 414, 416 may be encoded into an expected input format for the transformer models 418, 420, 422, such as an expected coordinate space, data format, and the like.

In certain implementations, the computing device 402 may be further configured to determine sensor capabilities 440 of the plurality of sensors 404, 406 and to determine dimensions of the three-dimensional surface 430 based on the sensor capabilities 440. For example, the sensor capabilities 440 may include a maximum range of the sensors 404, 406, a resolution of the sensors 404, 406, a field of view of the sensors 404, 406, and the like. In certain implementations, determining the dimensions of the three-dimensional surface 430 may include determining a width of the surface 430 based on a range of the at least one top view sensor 404 and determining a height of the surface 430 based on a field of view of the at least one perspective view sensor 406. For example, and returning to FIG. 5A, the three-dimensional surface 500 has a width 510 and a height 508, which may be determined as noted above.

Returning to FIG. 4, in certain implementations, the computing device 402 may be further configured to determine, within sensor data 408 from the at least one perspective view sensor 406, a vanishing point 436 of a road on which the vehicle may be traveling and may determine a sampling resolution 438 (such as an increased sampling resolution) of at least one sensor of the plurality of sensors 404, 406 based on the vanishing point 436. In certain implementations, the sampling resolution 438 may be determined for the at least one perspective view sensor 406. In particular, the sample resolution 438 may be determined for a region surrounding the vanishing point 436 within sensor data 408 captured by the at least one perspective sensor 406. Long range data sampling using polar sample (such as perspective view sampling from the point of view of a vehicle) may be difficult, as the same angular frequency results in reduced spatial frequency for long distances when compared to short distances. For example, FIG. 5B depicts a sampling scenario 520 according to an exemplary embodiment of the present disclosure that includes a polar sampling arrangement 522. As can be seen in the arrangement 522, at close distances, polar sampling has higher spatial resolution than at further distances, where the same angular pixel covers a larger amount of space. Despite such arrangements, long range accuracy and detail may be important for proper performance with vehicle applications, especially in the front of the vehicle, such as to detect other vehicles or objects in the direction of travel for the vehicle. To improve the detail in the direction of travel, sampling resolution 438 for a corresponding perspective view sensor 406 may be increased for portions of a field of view that are likely to represent the vehicle's direction of travel. For example, the sampling resolution 438 may be increased by adjusting a binning strategy for the at least one perspective sensor 406 for corresponding pixels that cover an expected direction of travel for the vehicle. For example, the arrangement 522 also includes an increased sampling region 524, in which a sampling frequency (such as an imaging sampling frequency) is increased for the region in front of the vehicle. In such instances, the increase frequency provides the same or similar resolution for the further regions as for the closer regions at the original, lower sampling frequency. However, operating constraints (such as computational constraints, bandwidth constraints, power constraints, and the like) may reduce the ability to increase sampling frequency for all portions of a perspective view sensor's 406 field of view. Accordingly, the computing device 402 may identify a direction of travel for the vehicle based on the vanishing point 436 within sensor data 408 or corresponding encoded data 416 from the perspective view sensor 406. For example, FIG. 5C depicts a sampling scenario 530 according to an exemplary embodiment of the present disclosure. In the sampling scenario 530, sensor data 532 (such as imaging data) is captured by a perspective view sensor and captures the view from the front of a vehicle. A vanishing point 536 may be identified within the sensor data 532. For example, the spatial features within the captured image converge on a vanishing point 536, which may be identified by identifying lines (such as road markings, structural features, or other lines along the direction of travel) within the sensor data 532 and extrapolating the lines to identify the vanishing point 536 where the lines converge. The vanishing point 536 may serve as an indicator of where the vehicle is likely to travel, as the vanishing point 536 may move with changes in road elevation, road direction, and the like. Accordingly, the increased sampling resolution 438 may be applied to a region surrounding the vanishing point 536. For example, the sampling arrangement 534 includes an increased sampling region around the same location 538 as the vanishing point 536 within the sensor data 532.

The computing device 402 may be configured to determine, with a machine learning model 432, one or more characteristics 434 of the area surrounding the vehicle. In particular, the characteristics 434 may be determined based on the three-dimensional surface 430 containing the mapped data 424, 426. In certain implementations, the characteristics 434 may include one or more spatial features within the perspective or top views. In other implementations, the characteristics may include object or obstacle identification and location, such as road conditions, nearby vehicles, nearby objects, hazards, pedestrians, road signs, and the like. In further implementations, the characteristics 434 may be used to generate vehicle control instructions for a control system of the vehicle. In certain implementations, the model 432 may include multiple models configured to identify different types of characteristics. For example, the model 432 may include one or perception models, such as parametric models configured to identify boxes, lines, shapes, or other features within the mapped data 424, 426, 428. As another example, the perception models may include semantic models configured to identify one or more pixel-level features. As a further example, the perception models may include flow models configured to detect motion within the mapped data 424, 426, 428 (such as within consecutive sets of mapped data 424, 426, 428). As another example, the perception models may include elevation models configured to identify elevation information, structural information, surface material information, and the like for ground structure surrounding the vehicle. In still further implementations, the model 432 may include one or more tracking or task-oriented models, such as a tracking model to track objects or people over time or a task-oriented model to generate commands for achieving a particular goal (such as changing lanes, avoiding an obstacle, maintaining a speed limit).

In particular, the model 432 may be trained to utilize mapped data 424, 426, 428 that combine perspective and top views, rather than separate sensor data 406, 408 or encoded data 414, 416 for that separate the perspective and top views. Such implementations may enable the model 432 to utilize unified perspective learning across multiple views, including view agnostic feature learning and features that combine aspects from multiple views. By combining different views into a single, continuous input surface, the mapped data 424, 426, 428 avoids the need for multiple branches for the model 432 to handle the separate views (and separate sensor data related to the views). This may reducing model's 432 size and the corresponding computing resources necessary to implement the model 432 and to train the model 432. Furthermore, mapping two-dimensional sensor data onto a three-dimensional surface may significantly reduce the input file sizes necessary when compared to three-dimensional input data. However, by combining multiple views, the model 432 may still achieve similar accuracy levels to models that receive and require three-dimensional input data. Accordingly, the model 432 may have similar levels of accuracy while reducing file bandwidth costs, data storage costs, model size, model complexity, and the computing resources required to implement or train the model 432. Given the memory and computing requirements for typical deep learning models, these techniques may accordingly enable greater use of deep learning models for vehicle guidance and similar related processes.

In certain implementations, the computing device 402 may also include a processor and a memory (not depicted). The processor and the memory may implement one or more aspects of the computing device 402. For example, the memory may store instructions which, when executed by the processor, may cause the processor to perform one or more operational features of the computing device 402. The processor may be implemented as one or more central processing units (CPUs), field programmable gate arrays (FPGAs), and/or graphics processing units (GPUs) configured to execute instructions stored on the memory. Additionally, the computing device 402 may be configured to communicate using a network. For example, the computing device 402 may communicate with the network using one or more wired network interfaces (e.g., Ethernet interfaces) and/or wireless network interfaces (e.g., Wi-Fi®, Bluetooth®, and/or cellular data interfaces). In certain instances, the network may be implemented as a local network (e.g., a local area network), a virtual private network, L1, and/or a global network (e.g., the Internet).

For example, the models 410, 412, 418, 420, 422, 432 may be implemented as one or more machine learning models, including supervised learning models, unsupervised learning models, other types of machine learning models, and/or other types of predictive models. For example, the models 410, 412, 418, 420, 422, 432 may be implemented as one or more of a neural network, a transformer model, a decision tree model, a support vector machine, a Bayesian network, a classifier model, a regression model, and the like. The models 410, 412, 418, 420, 422, 432 may be trained based on training data that specifies one or more expected outputs. In particular, as noted above, the model 432 may be trained based on a training data set that contains training data that has been mapped onto a three-dimensional surface to combine perspective view data and top view sensor data. Parameters of the models 410, 412, 418, 420, 422, 432 may be updated based on whether the models 410, 412, 418, 420, 422, 432 generates correct outputs when compared to the expected outputs. In particular, the models 410, 412, 418, 420, 422, 432 may receive one or more pieces of input data from the training data sets that are associated with a plurality of expected outputs. The models 410, 412, 418, 420, 422, 432 may generate predicted outputs based on a current configuration of the models 410, 412, 418, 420, 422, 432. The predicted outputs may be compared to the expected outputs and one or more parameter updates may be computed based on differences between the predicted outputs and the expected outputs. The parameter updates for the models 410, 412, 418, 420, 422, 432 may include updating one or more of the features analyzed and/or the weights assigned to different features or combinations of features (e.g., relative to the current configuration of the models 410, 412, 418, 420, 422, 432).

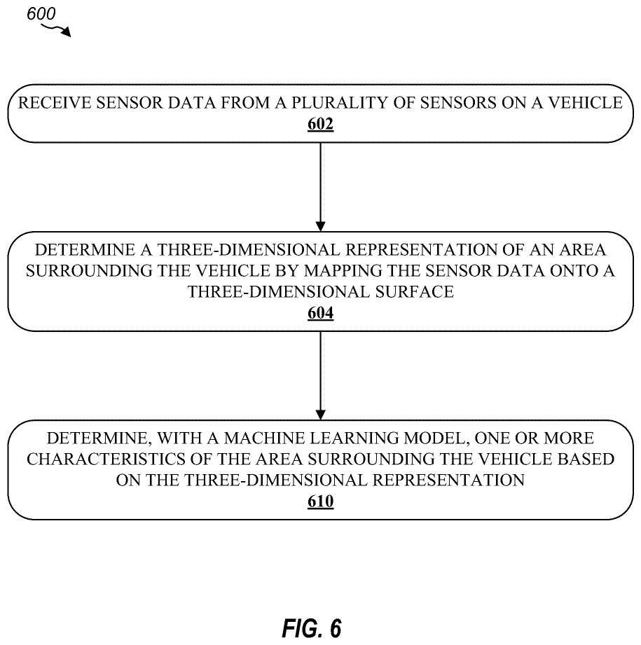

One method of performing image processing according to embodiments described above is shown in FIG. 6. FIG. 6 is a flow chart illustrating an example method 600 for processing sensor data for machine learning applications according to an exemplary embodiment of the present disclosure. The method 600 may be performed by one or more of the above systems, such as the system 400. The method 600 may be implemented on a computer system, such as the system 400. For example, the method 600 may be implemented by the computing device 402. The method 600 may also be implemented by a set of instructions stored on a computer readable medium that, when executed by a processor, cause the computing device to perform the method 600. Although the examples below are described with reference to the flowchart illustrated in FIG. 6, many other methods of performing the acts associated with FIG. 6 maybe used. For example, the order of some of the blocks may be changed, certain blocks may be combined with other blocks, one or more of the blocks may be repeated, and some of the blocks may be optional.

The method 600 includes receiving sensor data from a plurality of sensors on a vehicle (block 602). For example, the computing device 402 may receive sensor data 407, 408 from a plurality of sensors 404, 406 on a vehicle. The plurality of sensors 404, 406 may include at least one perspective view sensor 406 and at least one top view sensor 404. In certain implementations, the perspective view may be an outward-facing view of the area surrounding the vehicle. In certain implementations, the top view may be a top-down view of the vehicle and the area surrounding the vehicle. In certain implementations, the sensor data 407, 408 may be two-dimensional data.

The method 600 includes determining a three-dimensional representation of an area surrounding the vehicle (block 604). For example, the computing device 402 may determine a three-dimensional representation of an area surrounding the vehicle by mapping the sensor data 407, 408 onto a three-dimensional surface 430. The three-dimensional surface 430 may include sensor data 408 from the at least one perspective view sensor 406 and sensor data 407 from the at least one top view sensor 404. The three-dimensional surface 430 may be continuous. For example, the three-dimensional surface 430 may be a capped cylinder with a rounded edge. In certain implementations, mapping the sensor data 407, 408 onto the three-dimensional surface 430 may include mapping sensor data 408 from the at least one perspective view sensor 406 onto a first portion of the three-dimensional surface 430 (such as sides of the three-dimensional surface 430) and mapping sensor data 407 from the at least one top view sensor 404 onto a second portion of the three-dimensional surface 430 (such as a top surface of the three-dimensional surface 430). In certain implementations, sensor data 408 from the at least one perspective view sensor 406 may be mapped onto the first portion of the three-dimensional surface 430 by a first transformer model 422, sensor data 407 from the at least one top view sensor 404 may be mapped onto the second portion of the three-dimensional surface 430 by a second transformer model 418, and sensor data 407, 408 from both the at least one perspective view sensor 406 and the at least one top view sensor 404 may be mapped onto a third portion of the three-dimensional surface 430 between the first portion and the second portion of the three-dimensional surface 430 by a third transformer model 420 (such as a transition surface of the three-dimensional surface 430). In certain implementations, sensor data 407, 408 from the at least one perspective sensor and sensor data 407 from the at least one top view sensor 404 are separately encoded by corresponding encoder models 410, 412 before being mapped onto the three-dimensional surface 430. In such implementations, corresponding encoded data 414, 416 may be mapped instead of the sensor data 407, 408. In certain implementations, the method further includes determining sensor capabilities 440 of the plurality of sensors and determining dimensions of the three-dimensional surface 430 based on the sensor capabilities 440. In certain implementations, the method 600 further includes determining the dimensions may include determining a width of the surface based on a range of the at least one top view sensor 404 and determining a height of the surface based on a field of view of the at least one perspective view sensor 406. In certain implementations, the method 600 further includes determining, within sensor data 408 from the at least one perspective view sensor 406, a vanishing point 436 of a road on which the vehicle is traveling and determining an increased sampling resolution 438 of the at least one perspective view sensor 406 within a region surrounding the vanishing point 436.

The method 600 includes determining, with a machine learning model, one or more characteristics of the area surrounding the vehicle. (block 606). For example, the computing device 402 may determine, with a machine learning model 432, one or more characteristics 434 of the area surrounding the vehicle based on the three-dimensional surface 430 containing the mapped data 424, 426, 428. The characteristics 434 may include one or more spatial characteristics reflected in the mapped data 424, 426, 428 and/or may include detecting and monitoring objects and people within the area surrounding the vehicle. In certain implementations, the characteristics 434 may be used to generate one or more control instructions for the vehicle.

It is noted that one or more blocks (or operations) described with reference to FIG. 6 may be combined with one or more blocks (or operations) described with reference to another of the figures. For example, one or more blocks (or operations) of FIG. 6 may be combined with one or more blocks (or operations) of FIG. 1-3. As another example, one or more blocks associated with FIG. 6 may be combined with one or more blocks associated with FIG. 4.

In one or more aspects, techniques for supporting vehicular operations may include additional aspects, such as any single aspect or any combination of aspects described below or in connection with one or more other processes or devices described elsewhere herein. A first aspect includes a method that includes receiving sensor data from a plurality of sensors on a vehicle, where the plurality of sensors includes at least one perspective view sensor and at least one top view sensor. The method also includes determining a three-dimensional representation of an area surrounding the vehicle by mapping the sensor data onto a three-dimensional surface, where the three-dimensional surface includes sensor data from the at least one perspective view sensor and sensor data from the at least one top view sensor, where the three-dimensional surface is continuous. Mapping the sensor data onto the three-dimensional surface may include mapping sensor data from the at least one perspective view sensor onto sides of the three-dimensional surface, and mapping sensor data from the at least one top view sensor onto a top of the three-dimensional surface. The method also includes determining, with a machine learning model, one or more characteristics of the area surrounding the vehicle based on the three-dimensional representation. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the sensor data from the at least one perspective view sensor is mapped onto sides of the three-dimensional surface by a first transformer model, sensor data from the at least one top view sensor is mapped onto the top of the three-dimensional surface by a second transformer model, and sensor data from both the at least one perspective view sensor and the at least one top view sensor is mapped onto a transition region between the sides and top of the three-dimensional surface.

In a third aspect, in combination with one or more of the first aspect through the second aspect, sensor data from the at least one perspective view sensor and sensor data from the at least one top view sensor are separately encoded by corresponding encoding models before being mapped onto the three-dimensional surface.

In a fourth aspect, in combination with one or more of the first aspect through the third aspect, the three-dimensional surface is a capped cylinder with a rounded edge.

In a fifth aspect, in combination with one or more of the first aspect through the fourth aspect, the perspective view sensor captures sensor data for an outward-facing view of the area surrounding the vehicle and the top view sensor captures sensor data for a top-down view of the vehicle and the area surrounding the vehicle.

In a sixth aspect, in combination with one or more of the first aspect through the fifth aspect, the method includes determining sensor capabilities of the plurality of sensors; and determining dimensions of the three-dimensional surface based on the sensor capabilities.

In a seventh aspect, in combination with the sixth aspect, determining the dimensions includes determining a width of the three-dimensional surface based on a range of the at least one top view sensor and determining a height of the three-dimensional surface based on a field of view of the at least one perspective view sensor.

In an eighth aspect, in combination with one or more of the first aspect through the seventh aspect, the method includes determining, within sensor data from the at least one perspective view sensor, a vanishing point of a road on which the vehicle is traveling; and determining an increased sampling resolution of the at least one perspective view sensor within a region surrounding the vanishing point.

In a ninth aspect, in combination with one or more of the first aspect through the eighth aspect, the method includes, prior to determining the one or more characteristics with the machine learning model, training the machine learning model with a training dataset that contains training data mapped onto three-dimensional surfaces.

In a tenth aspect, in combination with one or more of the first aspect through the ninth aspect, the method includes determining, based on the one or more characteristics, one or more control instructions for the vehicle.

An eleventh aspect includes an apparatus that includes a memory storing processor-readable code. The apparatus also includes at least one processor coupled to the memory, the at least one processor configured to execute the processor-readable code to cause the at least one processor to perform operations. The operations may include receiving sensor data from a plurality of sensors on a vehicle, where the plurality of sensors includes at least one perspective view sensor and at least one top view sensor. The operations also includes determining a three-dimensional representation of an area surrounding the vehicle by mapping the sensor data onto a three-dimensional surface, where the three-dimensional surface includes sensor data from the at least one perspective view sensor and sensor data from the at least one top view sensor, where the three-dimensional surface is continuous, and where mapping the sensor data onto the three-dimensional surface includes: [symbol] . The operations also includes mapping sensor data from the at least one perspective view sensor onto sides of the three-dimensional surface. The operations also includes mapping sensor data from the at least one top view sensor onto a top of the three-dimensional surface. The operations also include determining, with a machine learning model, one or more characteristics of the area surrounding the vehicle based on the three-dimensional representation.

In a twelfth aspect, in combination with the eleventh aspect, sensor data from the at least one perspective view sensor is mapped onto sides of the three-dimensional surface by a first transformer model, sensor data from the at least one top view sensor is mapped onto the top of the three-dimensional surface by a second transformer model, and sensor data from both the at least one perspective view sensor and the at least one top view sensor is mapped onto a transition region between the sides and top of the three-dimensional surface.

In a thirteenth aspect, in combination with one or more of the eleventh aspect through the twelfth aspect, sensor data from the at least one perspective view sensor and sensor data from the at least one top view sensor are separately encoded by corresponding encoding models before being mapped onto the three-dimensional surface.

In a fourteenth aspect, in combination with one or more of the eleventh aspect through the thirteenth aspect, the three-dimensional surface is a capped cylinder with a rounded edge.

In a fifteenth aspect, in combination with one or more of the eleventh aspect through the fourteenth aspect, the perspective view sensor captures sensor data for an outward-facing view of the area surrounding the vehicle and the top view sensor captures sensor data for a top-down view of the vehicle and the area surrounding the vehicle.

In a sixteenth aspect, in combination with one or more of the eleventh aspect through the fifteenth aspect, the operations further include determining sensor capabilities of the plurality of sensors; and determining dimensions of the three-dimensional surface based on the sensor capabilities.

In a seventeenth aspect, in combination with the sixteenth aspect, the determining the dimensions includes determining a width of the three-dimensional surface based on a range of the at least one top view sensor and determining a height of the three-dimensional surface based on a field of view of the at least one perspective view sensor.

In an eighteenth aspect, in combination with one or more of the eleventh aspect through the seventeenth aspect, the operations further include determining, within sensor data from the at least one perspective view sensor, a vanishing point of a road on which the vehicle is traveling; and determining an increased sampling resolution of the at least one perspective view sensor within a region surrounding the vanishing point.

In a nineteenth aspect, in combination with one or more of the eleventh aspect through the eighteenth aspect, the operations further may include, prior to determining the one or more characteristics with the machine learning model, training the machine learning model with a training dataset that contains training data mapped onto three-dimensional surfaces.

In a twentieth aspect, in combination with one or more of the eleventh aspect through the nineteenth aspect, the operations further may include determining, based on the one or more characteristics, one or more control instructions for the vehicle.

A twenty-first aspect includes a non-transitory computer-readable medium storing instructions that that, when executed by a processor, cause the processor to perform operations. The operations may include receiving sensor data from a plurality of sensors on a vehicle, where the plurality of sensors includes at least one perspective view sensor and at least one top view sensor. The instructions also include determining a three-dimensional representation of an area surrounding the vehicle by mapping the sensor data onto a three-dimensional surface, where the three-dimensional surface includes sensor data from the at least one perspective view sensor and sensor data from the at least one top view sensor, where the three-dimensional surface is continuous, and where mapping the sensor data onto the three-dimensional surface includes: [symbol] . The instructions also include mapping sensor data from the at least one perspective view sensor onto sides of the three-dimensional surface. The instructions also includes mapping sensor data from the at least one top view sensor onto a top of the three-dimensional surface. The instructions also includes determining, with a machine learning model, one or more characteristics of the area surrounding the vehicle based on the three-dimensional representation.

In a twenty-second aspect, in combination with the twenty-first aspect, sensor data from the at least one perspective view sensor is mapped onto sides of the three-dimensional surface by a first transformer model, sensor data from the at least one top view sensor is mapped onto the top of the three-dimensional surface by a second transformer model, and sensor data from both the at least one perspective view sensor and the at least one top view sensor is mapped onto a transition region between the sides and top of the three-dimensional surface.

In a twenty-third aspect, in combination with one or more of the twenty-first aspect through the twenty-second aspect, the operations further include determining sensor capabilities of the plurality of sensors; and determining dimensions of the three-dimensional surface based on the sensor capabilities.

In a twenty-fourth aspect, in combination with the twenty-third aspect, determining the dimensions includes determining a width of the three-dimensional surface based on a range of the at least one top view sensor and determining a height of the three-dimensional surface based on a field of view of the at least one perspective view sensor.

In a twenty-fifth aspect, in combination with one or more of the twenty-first aspect through the twenty-fourth aspect, the operations further may include: determining, within sensor data from the at least one perspective view sensor, a vanishing point of a road on which the vehicle is traveling; and determining an increased sampling resolution of the at least one perspective view sensor within a region surrounding the vanishing point.

A twenty-sixth aspect includes a vehicle that a memory storing processor-readable code. The vehicle also includes at least one processor coupled to the memory, the at least one processor configured to execute the processor-readable code to cause the at least one processor to perform operations including: receiving sensor data from a plurality of sensors on a vehicle, where the plurality of sensors includes at least one perspective view sensor and at least one top view sensor; determining a three-dimensional representation of an area surrounding the vehicle by mapping the sensor data onto a three-dimensional surface, where the three-dimensional surface includes sensor data from the at least one perspective view sensor and sensor data from the at least one top view sensor, where the three-dimensional surface is continuous. Mapping the sensor data onto the three-dimensional surface includes mapping sensor data from the at least one perspective view sensor onto sides of the three-dimensional surface; and mapping sensor data from the at least one top view sensor onto a top of the three-dimensional surface. The operations may include determining, with a machine learning model, one or more characteristics of the area surrounding the vehicle based on the three-dimensional representation.

In a twenty-seventh aspect, in combination with the twenty-sixth aspect, sensor data from the at least one perspective view sensor is mapped onto sides of the three-dimensional surface by a first transformer model, sensor data from the at least one top view sensor is mapped onto the top of the three-dimensional surface by a second transformer model, and sensor data from both the at least one perspective view sensor and the at least one top view sensor is mapped onto a transition region between the sides and top of the three-dimensional surface.

In a twenty-eighth aspect, in combination with one or more of the twenty-sixth aspect through the twenty-seventh aspect, the operations further may include: determining sensor capabilities of the plurality of sensors; and determining dimensions of the three-dimensional surface based on the sensor capabilities.

In a twenty-ninth aspect, in combination with the twenty-eighth aspect, determining the dimensions includes determining a width of the three-dimensional surface based on a range of the at least one top view sensor and determining a height of the three-dimensional surface based on a field of view of the at least one perspective view sensor.

In a thirtieth aspect, in combination with one or more of the twenty-sixth aspect through the twenty-ninth aspect, the operations further comprise determining, within sensor data from the at least one perspective view sensor, a vanishing point of a road on which the vehicle is traveling; and determining an increased sampling resolution of the at least one perspective view sensor within a region surrounding the vanishing point.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method comprising:
receiving sensor data from a plurality of sensors on a vehicle, wherein the sensor data comprises first sensor data from at least one perspective view sensor and second sensor data from at least one top view sensor;
determining a three-dimensional representation of an area surrounding the vehicle by mapping the sensor data onto a three-dimensional surface of the three-dimensional representation, wherein the three-dimensional surface includes the first sensor data from the at least one perspective view sensor and the second sensor data from the at least one top view sensor, wherein the three-dimensional surface is continuous, and wherein mapping the sensor data onto the three-dimensional surface includes:
mapping the first sensor data from the at least one perspective view sensor onto a first portion of the three-dimensional surface; and
mapping the second sensor data from the at least one top view sensor onto a second portion of the three-dimensional surface; and
determining, with a machine learning model, one or more characteristics of the area surrounding the vehicle based on the three-dimensional representation.

2. The method of claim 1, wherein the first sensor data from the at least one perspective view sensor is mapped onto the first portion of the three-dimensional surface by a first transformer model, the second sensor data from the at least one top view sensor is mapped onto the second portion of the three-dimensional surface by a second transformer model, and sensor data from both the at least one perspective view sensor and the at least one top view sensor is mapped onto a third portion of the three-dimensional surface between the first portion and the second portion of the three-dimensional surface.

3. The method of claim 1, wherein the first sensor data from the at least one perspective view sensor and the second sensor data from the at least one top view sensor are separately encoded by corresponding encoding models before being mapped onto the three-dimensional surface.

4. The method of claim 1, wherein the three-dimensional surface is a capped cylinder with a rounded edge.

5. The method of claim 1, wherein the perspective view sensor captures sensor data for an outward-facing view of the area surrounding the vehicle and the top view sensor captures sensor data for a top-down view of the vehicle and the area surrounding the vehicle.

6. The method of claim 1, further comprising:
determining sensor capabilities of the plurality of sensors; and
determining dimensions of the three-dimensional surface based on the sensor capabilities.

7. The method of claim 6, wherein determining the dimensions includes determining a width of the three-dimensional surface based on a range of the at least one top view sensor and determining a height of the three-dimensional surface based on a field of view of the at least one perspective view sensor.

8. The method of claim 1, further comprising:
determining, within the first sensor data from the at least one perspective view sensor, a vanishing point of a road on which the vehicle is traveling; and
determining an increased sampling resolution of the at least one perspective view sensor within a region surrounding the vanishing point.

9. The method of claim 1, further comprising, prior to determining the one or more characteristics with the machine learning model, training the machine learning model with a training dataset that contains training data mapped onto three-dimensional surfaces.

10. The method of claim 1, further comprising determining, based on the one or more characteristics, one or more control instructions for the vehicle.

11. An apparatus, comprising:
a memory storing processor-readable code; and
at least one processor coupled to the memory, the at least one processor configured to execute the processor-readable code to cause the at least one processor to perform operations including:
receiving sensor data from a plurality of sensors on a vehicle, wherein the sensor data comprises first sensor data from at least one perspective view sensor and second sensor data from at least one top view sensor;
determining a three-dimensional representation of an area surrounding the vehicle by mapping the sensor data onto a three-dimensional surface, wherein the three-dimensional surface includes the first sensor data from the at least one perspective view sensor and the second sensor data from the at least one top view sensor, wherein the three-dimensional surface is continuous, and wherein mapping the sensor data onto the three-dimensional surface includes:
mapping the first sensor data from the at least one perspective view sensor onto a first portion of the three-dimensional surface; and
mapping the second sensor data from the at least one top view sensor onto a second portion of the three-dimensional surface; and
determining, with a machine learning model, one or more characteristics of the area surrounding the vehicle based on the three-dimensional representation.

12. The apparatus of claim 11, wherein the first sensor data from the at least one perspective view sensor is mapped onto the first portion of the three-dimensional surface by a first transformer model, the second sensor data from the at least one top view sensor is mapped onto the second portion of the three-dimensional surface by a second transformer model, and sensor data from both the at least one perspective view sensor and the at least one top view sensor is mapped onto a portion of the three-dimensional surface between the first portion and the second portion of the three-dimensional surface.

13. The apparatus of claim 11, wherein the first sensor data from the at least one perspective view sensor and the second sensor data from the at least one top view sensor are separately encoded by corresponding encoding models before being mapped onto the three-dimensional surface.

14. The apparatus of claim 11, wherein the three-dimensional surface is a capped cylinder with a rounded edge.

15. The apparatus of claim 11, wherein the perspective view sensor captures sensor data for an outward-facing view of the area surrounding the vehicle and the top view sensor captures sensor data for a top-down view of the vehicle and the area surrounding the vehicle.

16. The apparatus of claim 11, wherein the operations further comprise:
determining sensor capabilities of the plurality of sensors; and
determining dimensions of the three-dimensional surface based on the sensor capabilities.

17. The apparatus of claim 16, wherein determining the dimensions includes determining a width of the three-dimensional surface based on a range of the at least one top view sensor and determining a height of the three-dimensional surface based on a field of view of the at least one perspective view sensor.

18. The apparatus of claim 11, wherein the operations further comprise:
determining, within the first sensor data from the at least one perspective view sensor, a vanishing point of a road on which the vehicle is traveling; and
determining an increased sampling resolution of the at least one perspective view sensor within a region surrounding the vanishing point.

19. The apparatus of claim 11, wherein the operations further comprise, prior to determining the one or more characteristics with the machine learning model, training the machine learning model with a training dataset that contains training data mapped onto three-dimensional surfaces.

20. The apparatus of claim 11, wherein the operations further comprise determining, based on the one or more characteristics, one or more control instructions for the vehicle.

21. A non-transitory computer-readable medium storing instructions that, when executed by a processor, cause the processor to perform operations comprising:
receiving sensor data from a plurality of sensors on a vehicle, wherein the sensor data comprises first sensor data from at least one perspective view sensor and second sensor data from at least one top view sensor;
determining a three-dimensional representation of an area surrounding the vehicle by mapping the sensor data onto a three-dimensional surface, wherein the three-dimensional surface includes the first sensor data from the at least one perspective view sensor and the second sensor data from the at least one top view sensor, wherein the three-dimensional surface is continuous, and wherein mapping the sensor data onto the three-dimensional surface includes:
mapping the first sensor data from the at least one perspective view sensor onto a first portion of the three-dimensional surface; and
mapping the second sensor data from the at least one top view sensor onto a second portion of the three-dimensional surface; and
determining, with a machine learning model, one or more characteristics of the area surrounding the vehicle based on the three-dimensional representation.

22. The non-transitory computer-readable medium of claim 21, wherein the first sensor data from the at least one perspective view sensor is mapped onto the first portion of the three-dimensional surface by a first transformer model, the second sensor data from the at least one top view sensor is mapped onto the second portion of the three-dimensional surface by a second transformer model, and sensor data from both the at least one perspective view sensor and the at least one top view sensor is mapped onto a third portion of the three-dimensional surface between the first portion and the second portion of the three-dimensional surface.

23. The non-transitory computer-readable medium of claim 21, wherein the operations further comprise:
determining sensor capabilities of the plurality of sensors; and
determining dimensions of the three-dimensional surface based on the sensor capabilities.

24. The non-transitory computer-readable medium of claim 23, wherein determining the dimensions includes determining a width of the three-dimensional surface based on a range of the at least one top view sensor and determining a height of the three-dimensional surface based on a field of view of the at least one perspective view sensor.

25. The non-transitory computer-readable medium of claim 21, wherein the operations further comprise:
determining, within the first sensor data from the at least one perspective view sensor, a vanishing point of a road on which the vehicle is traveling; and
determining an increased sampling resolution of the at least one perspective view sensor within a region surrounding the vanishing point.

26. A vehicle, comprising:
a plurality of sensors comprising at least one perspective view sensor and at least one top view sensor;
a memory storing processor-readable code; and
at least one processor coupled to the memory, the at least one processor configured to execute the processor-readable code to cause the at least one processor to perform operations including:
receiving sensor data from the plurality of sensors, wherein the sensor data comprises first sensor data from the at least one perspective view sensor and second sensor data from the at least one top view sensor;
determining a three-dimensional representation of an area surrounding the vehicle by mapping the sensor data onto a three-dimensional surface, wherein the three-dimensional surface includes the first sensor data from the at least one perspective view sensor and the second sensor data from the at least one top view sensor, wherein the three-dimensional surface is continuous, and wherein mapping the sensor data onto the three-dimensional surface includes:
mapping the first sensor data from the at least one perspective view sensor onto a first portion of the three-dimensional surface; and
mapping the second sensor data from the at least one top view sensor onto a second portion of the three-dimensional surface; and
determining, with a machine learning model, one or more characteristics of the area surrounding the vehicle based on the three-dimensional representation.

27. The vehicle of claim 26, wherein the first sensor data from the at least one perspective view sensor is mapped onto the first portion of the three-dimensional surface by a first transformer model, the second sensor data from the at least one top view sensor is mapped onto the second portion of the three-dimensional surface by a second transformer model, and sensor data from both the at least one perspective view sensor and the at least one top view sensor is mapped onto a third portion between the first portion and the second portion of the three-dimensional surface.

28. The vehicle of claim 26, wherein the operations further comprise:
determining sensor capabilities of the plurality of sensors; and
determining dimensions of the three-dimensional surface based on the sensor capabilities.

29. The vehicle of claim 28, wherein determining the dimensions includes determining a width of the three-dimensional surface based on a range of the at least one top view sensor and determining a height of the three-dimensional surface based on a field of view of the at least one perspective view sensor.

30. The vehicle of claim 26, wherein the operations further comprise:
determining, within the first sensor data from the at least one perspective view sensor, a vanishing point of a road on which the vehicle is traveling; and
determining an increased sampling resolution of the at least one perspective view sensor within a region surrounding the vanishing point.
